(19) United States
(12) Patent Application Publication
(10) Pub. No.: US 2025/0310637 A1
(43) Pub. Date: Oct. 2, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: RYO IMAI, Kanagawa (JP)

(21) Appl. No.: 19/085,790

(22) Filed: Mar. 20, 2025

(30) Foreign Application Priority Data
Mar. 29, 2024 (JP) 2024-055832

(51) Int. Cl. H04N 23/60; H04N 23/661

(52) U.S. Cl. CPC H04N 23/64; H04N 23/661

(57) ABSTRACT

An information processing apparatus includes an acquisition unit that acquires an imaging start request for requesting start of acquisition of image data or an imaging end request for requesting end of acquisition of the image data from a cooperating apparatus, and a control unit configured to cause an imaging unit to acquire the image data based on the imaging start request and the imaging end request, and write the image data into a predetermined file in the one or more memories, wherein when the acquired imaging end request is not a final imaging end request among a plurality of acquired imaging end requests corresponding to a plurality of acquired imaging start requests, the control unit continues to cause the imaging unit to acquire the image data and changes a file into which the image data is to be written from the predetermined file into a different file.

### BACKGROUND

### Field

The present disclosure relates to an information processing apparatus, a control method of an information processing apparatus, and a storage medium.

### Description of the Related Art

In recent years, at competitive sport events typified by the Olympics, photographers have captured a wide variety of competitive scenes. Many of the captured photos and moving images have been distributed in the media news. In order to capture a wide variety of scenes, a plurality of photographers is needed, which would incur additional labor costs.

A plurality of digital cameras is installed at various angles at the competition venue, and the digital cameras are connected to a control apparatus such as a tablet or laptop computer via a network. This allows one or more photographers to operate the control apparatus and remotely capture images using the plurality of digital cameras.

Since the photographers use the system that can control the plurality of digital cameras, it is possible to perform image capture and transfer by a minimum number of persons, so that a large number of images can be captured with a variety of compositions while achieving cost reduction.

As remote imaging systems that are capable of remotely controlling a plurality of digital cameras, existing technologies such as “NX Field” (registered trademark) provided by Nikon Corporation and “Remote Camera Tool” (registered trademark) provided by Sony Corporation may be used.

In such a remote imaging system, if a plurality of control apparatuses exists on a network, the plurality of control apparatuses may each transmit a moving image capturing instruction to a single digital camera. Japanese Patent Application Laid-Open No. 2017-147624 discusses a technology for a plurality of terminal devices to simultaneously control the operation timings of a camera.

However, according to the technology discussed in Japanese Patent Application Laid-Open No. 2017-147624, it is possible to capture a moving image for a period of time required by the plurality of terminal devices, but the moving image capturing operation is not ended until all of the terminal devices transmit an imaging end request signal. For this reason, in order to play back or transfer the captured results, it is necessary to wait for all of the terminal devices to transmit an imaging end request signal. Furthermore, because it takes time to transfer not only files of necessary scenes but also files of unnecessary scenes, it may not satisfy the workflow of photographers who are required to transfer the captured results immediately.

### SUMMARY

The present disclosure is directed to providing a remote imaging system that, even when a plurality of control apparatuses each transmits a moving image capturing instruction, allows each control apparatus to quickly check and transfer captured results.

According to an aspect of the present disclosure, an information processing apparatus includes one or more memories storing one or more programs, and one or more processors that, upon execution of the one or more programs, are configured to operate as an acquisition unit that acquires an imaging start request for requesting start of acquisition of image data or an imaging end request for requesting end of acquisition of the image data from a cooperating apparatus, and a control unit configured to cause an imaging unit to acquire the image data based on the imaging start request and the imaging end request, and write the image data into a predetermined file in the one or more memories, wherein when the acquired imaging end request is not a final imaging end request among a plurality of acquired imaging end requests corresponding to a plurality of acquired imaging start requests, the control unit continues to cause the imaging unit to acquire the image data and changes a file into which the image data is to be written from the predetermined file into a different file.

Further features of the present disclosure will become apparent from the following description of exemplary embodiments with reference to the attached drawings.

### BRIEF DESCRIPTION OF THE DRAWINGS

FIGS. 1A to 1C are a hardware configuration diagram illustrating a configuration of a digital camera and external views of the digital camera.

FIG. 2 is a hardware configuration diagram illustrating a configuration of a control apparatus.

FIG. 3 is a system configuration diagram illustrating an example of a network configuration.

FIG. 4 is an example of a flowchart according to a first exemplary embodiment.

FIG. 5 is an example of a flowchart according to a second exemplary embodiment.

### DESCRIPTION OF THE EMBODIMENTS

Preferred exemplary embodiments of the present disclosure will be described in detail with reference to the accompanying drawings.

The exemplary embodiments described below are examples of a means for carrying out the present disclosure, and may be modified or changed as appropriate depending on a configuration of the device to which the present disclosure is applied and various conditions. These exemplary embodiment may also be combined as appropriate.

### <Configuration of Digital Camera>

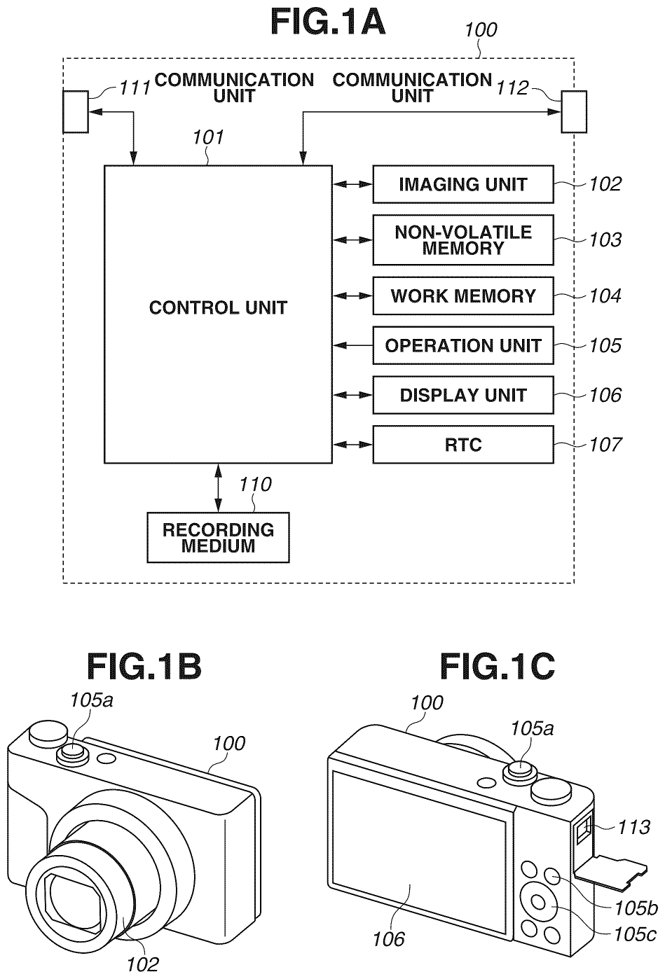

FIG. 1A is a hardware configuration diagram illustrating a configuration example of a digital camera 100, which is an example of an information processing apparatus of the present disclosure. A digital camera is taken here as an example of an information processing apparatus, but the information processing apparatus is not limited to the digital camera. For example, the information processing apparatus according to the present exemplary embodiment may be a smartphone, a tablet terminal, a personal computer (PC), or the like.

A control unit 101 controls each component of the digital camera 100 according to input signals and programs described below. Instead of the control unit 101 controlling the entire apparatus, a plurality of hardware devices may control the entire apparatus by sharing the processing.

For example, the control unit 101 causes an imaging unit 102 to acquire image data based on a moving image recording start signal and a moving image recording stop signal received from a control apparatus 200, and writes the image data into a predetermined file in a recording unit. Details will be described below.

The imaging unit 102 includes an optical lens unit, an optical system that controls an aperture, zoom, focus, or the like, and an imaging element for converting light (video) introduced through the optical lens unit into an electrical video signal, for example. As the imaging element, a complementary metal oxide semiconductor (CMOS) or a charge coupled device (CCD) is generally used. Under the control of the control unit 101, the imaging unit 102 converts the subject light imaged by the lens included in the imaging unit 102 into an electrical signal using the imaging element, and outputs digital data having undergone noise reduction processing and the like, as image data. In the digital camera 100 of the present exemplary embodiment, the image data is recorded on a recording medium 110 in accordance with the standard of Design Rule for Camera File System (DCF).

A non-volatile memory 103 is an electrically erasable and recordable non-volatile memory, and stores programs to be executed by the control unit 101, which will be described below.

A work memory 104 is used as a buffer memory that temporarily holds image data captured by the imaging unit 102, an image display memory for a display unit 106, a work area for the control unit 101, and the like.

An operation unit 105 is used to accept instructions to the digital camera 100 from the user. The operation unit 105 includes a power button for the user to instruct on/off of power supply to the digital camera 100, a release switch for instructing imaging, and a playback button for instructing playback of image data, for example. The operation unit 105 also includes operation members such as a dedicated connection button for starting communication with an external device via a communication unit 111 described below. The operation unit 105 also includes a touch panel formed on the display unit 106 described below. The release switch includes SW1 and SW2. When the release switch is in a half-pressed state, SW1 is turned on. Accordingly, the operation unit 105 accepts an instruction for performing preparatory processing for imaging, such as autofocus (AF), automatic exposure (AE), auto white balance (AWB), or flash preliminary light emission (EF). When the release switch is in a full-pressed state, SW2 is turned ON. Accordingly, the operation unit 105 accepts an instruction for imaging.

The display unit 106 displays a viewfinder image during imaging, captured image data, text for interactive operations, and the like. The display unit 106 does not necessarily have to be built in the digital camera 100. The digital camera 100 can be connected to the internal or external display unit 106, and has at least a display control function of controlling display on the display unit 106.

A real-time clock (RTC) 107 performs clock management. The RTC 107 may acquire the time set by a user using the operation unit 105, or may acquire and set time information via the communication unit 111, or may acquire a clock setting captured by a radio-controlled clock. The RTC 107 is simply required to perform time management.

The recording medium 110 can record image data output from the imaging unit 102.

The recording medium 110 may be detachable from the digital camera 100, or may be built in the digital camera 100. That is, the digital camera 100 is simply required to have at least a unit for accessing the recording medium 110.

The communication unit 111 is an interface for connecting to an external device. The digital camera 100 of the present exemplary embodiment can exchange data with the external device via the communication unit 111. For example, the digital camera 100 can receive a signal from the external device to control the operation of the imaging unit 102, or transmit moving image data generated by the imaging unit 102 to the external device via the communication unit 111.

In the present exemplary embodiment, the communication unit 111 includes an interface for communicating with an external device via a wireless local area network (LAN) conforming to the Institute of Electrical and Electronics Engineers (IEEE) 802.11 standard. The control unit 101 implements wireless communication with the external device by controlling the communication unit 111. The communication method is not limited to the wireless LAN, and also includes an infrared communication method, for example.

A communication unit 112 is an interface for connecting to an external device. The digital camera 100 of the present exemplary embodiment can exchange data with the external device via the communication unit 112. For example, the digital camera 100 can receive a signal from the external device to control the operation of the imaging unit 102, or transmit moving image data generated by the imaging unit 102 to the external device via the communication unit 112.

In the present exemplary embodiment, the communication unit 112 includes an interface for communicating with an external device via a wired LAN (Ethernet) conforming to the IEEE 802.3 standard. The control unit 101 implements communication with the external device by controlling the communication unit 112. The communication method is not limited to the wired LAN, and also includes a universal serial bus (USB) communication method, for example.

An external appearance of the digital camera 100 will be described. FIGS. 1B and 1C are diagrams illustrating an example of an external appearance of the digital camera 100. A release switch 105a, a playback button 105b, a direction key 105c, and a touch panel 105d are operation members included in the operation unit 105 described above. An image obtained through imaging by the imaging unit 102 is displayed on the display unit 106. The digital camera 100 of the present exemplary embodiment has a communication terminal of the communication unit 112 on a side surface of the camera housing. The communication unit 112 can communicate with an external device connected via this communication terminal over a wired LAN (Ethernet).

This concludes description of the digital camera 100.

### <Configuration of Control Apparatus>

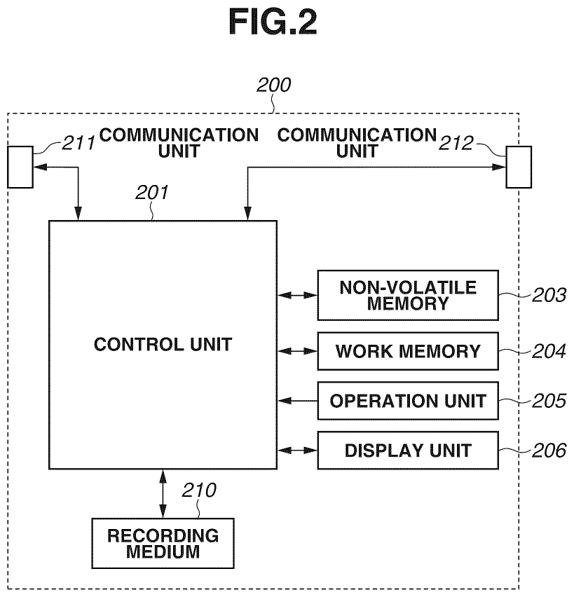

FIG. 2 is a hardware configuration diagram illustrating a configuration example of the control apparatus 200, which is an example of a cooperating apparatus of the present exemplary embodiment. The control apparatus 200 will be described as an example of a cooperating apparatus, but the cooperating apparatus is not limited to the control apparatus. For example, the cooperating apparatus may be a digital camera, a smartphone, a tablet terminal, a personal computer, or the like, which has a wireless function.

A control unit 201 controls each unit of the control apparatus 200 in accordance with input signals and programs described below. Instead of the control unit 201 controlling the entire apparatus, a plurality of hardware units may control the entire device by sharing the processing.

A non-volatile memory 203 is an electrically erasable and recordable non-volatile memory. The non-volatile memory 203 records an operating system (OS) that is basic software executed by the control unit 201 and applications which cooperate with the OS to implement applied functions. In the present exemplary embodiment, the non-volatile memory 203 stores an application for communicating with the digital camera 100.

A work memory 204 is used as an image display memory for a display unit 206, a work area for the control unit 201, and the like.

An operation unit 205 is used to receive instructions from a user to the control apparatus 200. The operation unit 205 includes operation members such as a power button for the user to instruct on/off of the control apparatus 200 and a touch panel formed on the display unit 206, for example.

The display unit 206 displays image data, text for interactive operations, and the like. The display unit 206 does not necessarily have to be included in the control apparatus 200. The control apparatus 200 is simply required to be connectable to the display unit 206 and has at least a display control function of controlling display on the display unit 206.

A recording medium 210 can record image data transmitted by the digital camera 100 to the control unit 201 via a communication unit 211. The recording medium 210 may be detachable from the control apparatus 200, or may be built in the control apparatus 200. That is, the control apparatus 200 is simply required to have at least a unit for accessing the recording medium 210.

The communication unit 211 is an interface for connecting to an external device. The control apparatus 200 of the present exemplary embodiment can exchange data with the external device via the communication unit 211. In the present exemplary embodiment, the communication unit 211 includes an interface for communicating with the external device via a wireless LAN conforming to the IEEE802.11 standard. The control unit 201 implements wireless communication with the external device by controlling the communication unit 211. The communication method is not limited to the wireless LAN, and also includes an infrared communication method, for example.

A communication unit 212 is an interface for communicating with an external device. The communication unit 212 includes an interface for communicating via a wired LAN (Ethernet) conforming to the IEEE 802.3 standard. The control unit 201 implements communication with the external device by controlling the communication unit 212. The communication method is not limited to the wired LAN, and also includes a USB communication method, for example.

### <System Configuration>

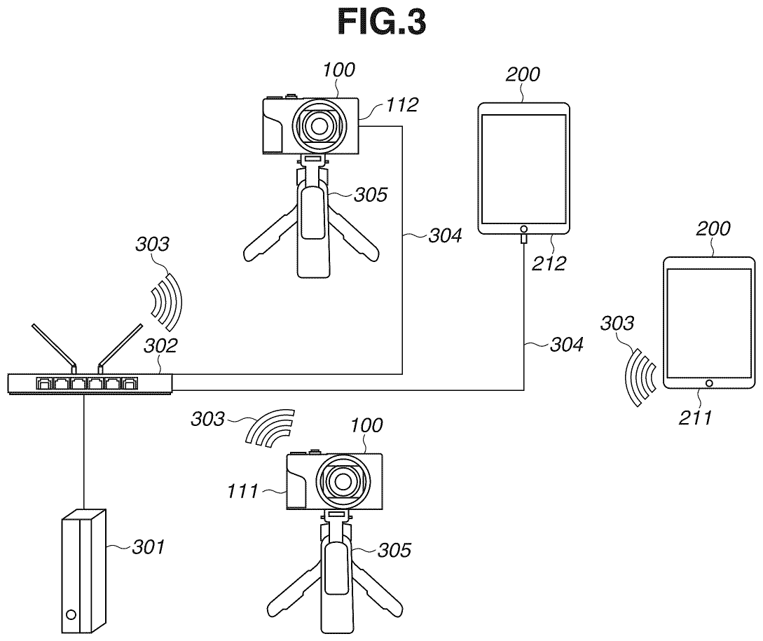

Next, a system configuration according to the exemplary embodiment will be described below with reference to FIG. 3. FIG. 3 illustrates an example of a network configuration.

A file transfer processing (FTP) server 301 includes a control unit, a communication unit, and a recording medium, and can receive a moving image file transmitted from the digital camera 100 via the communication unit and save the file on the recording medium.

As an example of a connection mode, the digital camera 100, the control apparatus 200, and the FTP server 301 are connected via a network device 302. The digital camera 100 may perform wireless communication with the network device 302 using radio waves 303 via the communication unit 111, or may perform wired communication with the network device 302 using a cable 304 via the communication unit 112. The control apparatus 200 may perform wireless communication with the network device 302 using radio waves 303 via the communication unit 211, or may perform wired communication with the network device 302 using a cable 304 via the communication unit 212.

The digital camera 100 is placed on a tripod 305 and installed at each imaging position. In the present exemplary embodiment, the digital camera 100 is placed on the tripod 305, but it may be placed on a remote pan head that enables remote control of pan, tilt, and zoom.

The following description of the present exemplary embodiment is based on the assumption that the digital camera 100 and the control apparatus 200 have the FTP server 301 and each other's IP addresses registered therein in advance, and that they are communicable with each other.

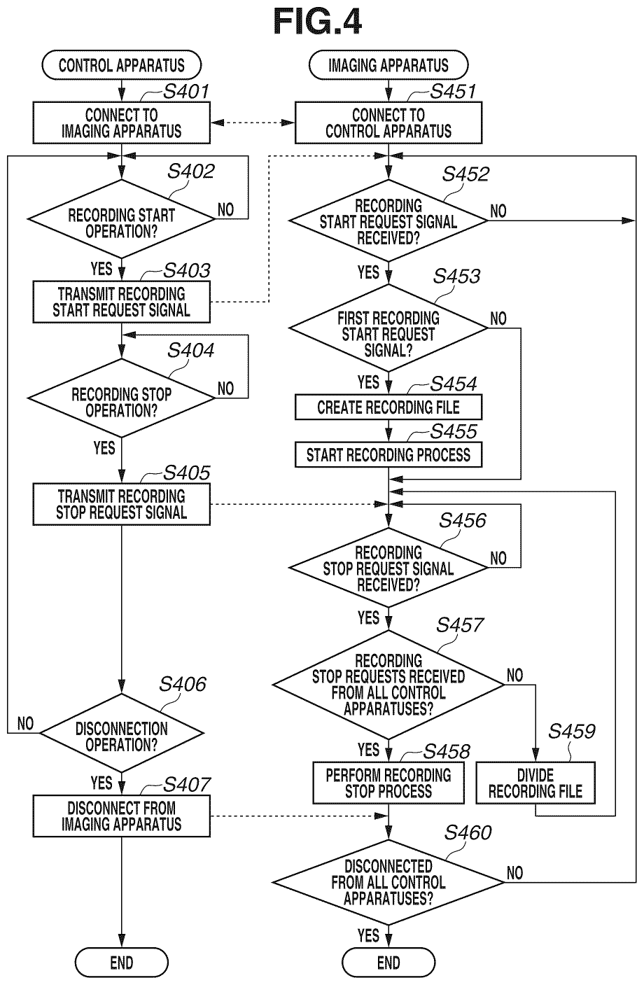

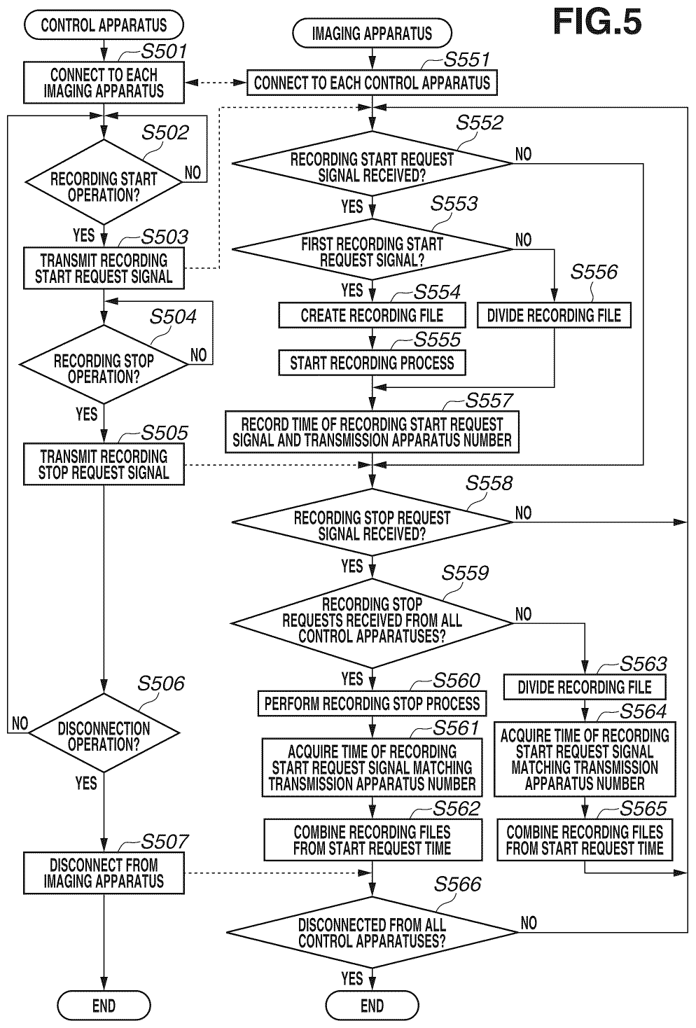

The operations in each exemplary embodiment of the present disclosure will be described with reference to FIGS. 4 and 5.

A first exemplary embodiment will be described. FIG. 4 illustrates an example of a flowchart of the control apparatus 200 to request the digital camera 100 to start and stop moving image recording. In the following description, an instruction to start moving image recording (start of image data acquisition) is an example of an imaging start request, and an instruction to stop moving image recording (end of image data acquisition) is an example of an imaging end request. However, the imaging start request and imaging end request according to the present exemplary embodiment are not limited to such examples. For example, they may be requests for continuous shooting instead of moving image recording. Specifically, the imaging start request may be a continuous shooting start request, and the imaging end request may be a continuous shooting end request.

The processing executed by the control apparatus 200 will be described.

In step S401, the control unit 201 controls the communication unit 211 or the communication unit 212 to connect to the digital camera 100.

In step S402, the control unit 201 determines whether a user has operated the operation unit 205 to instruct the digital camera 100 to start moving image recording. In a case where the user has instructed the digital camera 100 to start moving image recording (YES in step S402), the process proceeds to step S403. In a case where the user has not instructed to start moving image recording (NO in step S402), the process repeats step S402.

In step S403, the control unit 201 transmits a recording start request signal to the digital camera 100 via the communication unit 211 or the communication unit 212.

In step S404, the control unit 201 determines whether the user has operated the operation unit 205 to instruct the digital camera 100 to stop moving image recording. In a case where the user has instructed the digital camera 100 to stop moving image recording (YES in step S404), the process proceeds to step S405. In a case where the user has not instructed the digital camera 100 to stop moving image recording (NO in step S404), the process repeats step S404.

In step S405, the control unit 201 transmits a recording stop request signal to the digital camera 100 via the communication unit 211 or the communication unit 212.

In step S406, the control unit 201 determines whether the user has operated the operation unit 205 to instruct disconnection of the digital camera 100. In a case where the user has instructed disconnection (YES in step S406), the process proceeds to step S407, and in a case where the user has not instructed disconnection (NO in step S406), the process returns to step S402.

In step S407, the control unit 201 disconnects from the digital camera 100, and the process is ended.

This concludes the description of the processing executed by the control apparatus 200.

The processing executed by the digital camera 100 will be described.

In step S451, the control unit 101 controls the communication unit 111 or the communication unit 112 to connect to the control apparatus 200.

In step S452, the control unit 101 determines whether the recording start request signal has been received from the control apparatus 200 via the communication unit 111 or the communication unit 112. In a case where the signal has been received (YES in step S452), the process proceeds to step S453, and in a case where the signal has not been received (NO in step S452), the process repeats step S452.

In step S453, the control unit 101 determines whether the recording start request signal is the first one. In a case where the recording start request signal is the first one (YES in step S453), the process proceeds to step S454, and in a case where the recording start request signal is not the first one (NO in step S453), the process proceeds to step S456.

In step S454, the control unit 101 creates a recording file for recording the captured moving image on the recording medium 110.

In step S455, the control unit 101 starts the moving image recording process. In the recording process, under the control of the control unit 101, the imaging unit 102 converts the subject light image formed by the lens into an electrical signal by the imaging element, and performs noise reduction process and the like on the electrical signal, thereby to create image data. The control unit 101 controls the recording medium 110 to write the created image data in a file 1 in sequence.

In step S456, the control unit 101 determines whether the recording stop request signal has been received from the control apparatus 200 via the communication unit 111 or the communication unit 112. In a case where the signal has been received (YES in step S456), the process proceeds to step S457, and in a case where the signal has not been received (NO in step S456), the process repeats step S456 to continue the recording process.

In step S457, the control unit 101 determines whether the recording stop requests have been received from all of the control apparatuses 200 that have made the recording start requests. In a case where the recording stop requests have been received from all of the control apparatuses 200 (that is, in a case where the recording stop request has been received from the last control apparatus 200 among all of the control apparatuses 200 that have made the recording start requests) (YES in step S457), the process proceeds to step S458. In a case where the recording stop requests have not been received from all of the control apparatuses 200 (NO in step S457), the process proceeds to step S459.

In step S458, the control unit 101 stops the recording process, and controls the recording medium 110 to close the recording file as a file in which recording has been completed. Then, the process proceeds to step S460.

In step S459, the control unit 101 controls the recording medium 110 to perform a division process of the recording file. In the division process, the control unit 10 creates a recording file 2 different from the recording file 1 in which the image data is currently written, and changes the file in which the image data is to be written from the recording file 1 to the recording file 2 under the control of the control unit 101. Thereafter, the control unit 101 closes the recording file 1 as a file in which recording has been completed, and the process returns to step S452. In step S452, the control unit 101 continues the recording process.

In step S460, the control unit 101 determines whether the digital camera 100 has been disconnected from all of the control apparatuses 200 that are connected via the communication unit 111 or the communication unit 112. In a case where the digital camera 100 has been disconnected from all of the control apparatuses 200 (YES in step S460), the process is ended, and in a case where the digital camera 100 has not been disconnected from all of the control apparatuses 200 (NO in step S460), the process returns to step S452.

In the recording process in step S455, the image data created by the imaging unit 102 is recorded in the file 1, but the control unit 101 may create second image data lower in bit rate than the first image data written in the file 1. In this case, the second image data may be recorded in a file 3 different from the file 1. In this case, in the division process in step S459, the files in which image data is to be written may be changed to the file 2 and a file 4 lower in bit rate than the file 2, and the file 1 and the file 3 may be closed.

As described above, according to the first exemplary embodiment, even if recording start instructions are transmitted from a plurality of control apparatuses 200, a file of the imaging results can be saved without waiting for recording stop instructions from all of the control apparatuses 200 that have transmitted the recording start instructions. This file can also be transmitted to the control apparatus 200 for checking or to the FTP server 300. This makes it possible to satisfy the workflow of a photographer who is required to transfer the imaging results immediately.

A second exemplary embodiment will be described. FIG. 5 illustrates an example of a flowchart in which a control apparatus 200 requests a digital camera 100 to start and stop moving image recording.

Steps S501 to S507 executed by the control apparatus 200 are similar to steps S401 to S407 in FIG. 4, and thus description thereof will be omitted.

The processing executed by the digital camera 100 will be described.

In step 551, a control unit 101 controls a communication unit 111 or a communication unit 112 to connect to the control apparatus 200.

In step S552, the control unit 101 determines whether the recording start request signal has been received from the control apparatus 200 via the communication unit 111 or the communication unit 112. In a case where the signal has been received (YES in step S552), the process proceeds to step S553, and in a case where the signal has not been received (NO in step S552), the process proceeds to step S558.

In step S553, the control unit 101 determines whether the recording process has already been started by the control unit 101. In a case where the recording start request signal is the first one (YES in step S553), the process proceeds to step S554, and in a case where the recording start request signal is not the first one (NO in step S553), the process proceeds to step S556.

In step S554, the control unit 101 creates a recording file for recording the captured moving image on a recording medium 110.

In step S555, the control unit 101 starts a recording process of the moving image. The recording process is the same as that in step S455 in FIG. 4.

In step S556, the control unit 101 controls the recording medium 110 to perform a division process of the recording file. The division process is the same as that in step S459 in FIG. 4.

In step S557, the control unit 101 controls the communication unit 111 or the communication unit 112 and an RTC 107 to record information with which the control apparatuses that have transmitted the recording start request signals in step S552 can be identified (identification information) and the times when the recording start request signals are received (also called imaging start times) in association with each other. The recording destination may be a work memory 104 or the recording medium 110.

In step S558, the control unit 101 determines whether the recording stop request signal has been received from the control apparatus 200 via the communication unit 111 or the communication unit 112. In a case where the signal has been received (YES in step S558), the process proceeds to step S559, and in a case where the signal has not been received (NO in step S558), the process returns to step S552. In step S552, the control unit 101 continues the recording process.

In step S559, the control unit 101 determines whether the recording stop request has been received from all of the control apparatuses 200 that have made the recording start requests. In a case where the recording stop requests have been received from all of the control apparatuses 200 (YES in step S559), the process proceeds to step S458, and in a case where the recording stop requests have been received from all of the control apparatuses 200 (NO in step S559), the process proceeds to step S459.

In step S560, the control unit 101 stops the recording process, and controls the recording medium 110 to close the recording file as a file in which recording has been completed. Then, the process proceeds to step S561.

In step S561, the control unit 101 acquires the time associated with the control apparatus that has transmitted the recording stop request signal in step S558, from among the times at which the recording start request signals recorded in step S557 are received.

In step S562, the control unit 101 combines and saves the files recorded after the time acquired in step S561, and proceeds to step S566.

In step S563, the control unit 101 controls the recording medium 110 to perform a division process of the recording file. The division process is the same as that in step S459 in FIG. 4.

In step S564, the control unit 101 acquires the time associated with the control apparatus that has transmitted the recording stop request signal in step S558, from among the times at which the recording start request signals recorded in step S557 are received.

In step S565, the control unit 101 combines and saves the files recorded after the time acquired in step S561. The process returns to step S552. In step S552, the control unit 101 continues the recording process.

In step S566, the control unit 101 determines whether the digital camera 100 has been disconnected from all of the control apparatuses 200 that are connected via the communication unit 111 or the communication unit 112. In a case where the digital camera 100 has been disconnected from all of the control apparatuses 200 (YES in step S566), the process is ended. In a case where the digital camera 100 has not been disconnected from all of the control apparatuses 200 (NO in step S566), the process returns to step S552.

In the recording process in step S555, the image data created by the imaging unit 102 is recorded in the file 1, but the control unit 101 may create second image data lower in bit rate than the first image data written in the file 1. In this case, the control unit 101 may record the second image data in a file 3 different from the file 1. In this case, in the division process in steps S556 and S563, the files in which image data is to be written may be changed to the file 2 and a file 4 lower in bit rate than the file 2, and the file 1 and the file 3 may be closed.

As described above, according to the second exemplary embodiment, even if recording start instructions are transmitted from a plurality of control apparatuses 200, a file of the imaging results can be saved without waiting for recording stop instructions from all of the control apparatuses 200 that have transmitted the recording start instructions. This file can also be transmitted to the control apparatus 200 for checking or to an FTP server 300. In addition, since the moving images during the period from when each control apparatus 200 issues a recording start instruction to when each control apparatus 200 issues a recording stop instruction are combined and saved, it is possible to obtain the moving image of the necessary and sufficient period required by the user operating each control apparatus 200.

The various control operations described above as being performed by the control unit 101 and the control unit 201 may be performed by a single piece of hardware, or the entire apparatus may be controlled by a plurality of pieces of hardware (for example, a plurality of processors or circuits) sharing the processing.

The processes of the first and second exemplary embodiments may be combined. For example, in a case where it is determined in step S453 illustrated in FIG. 4 that the recording start request signal is not the first, the control unit 101 may control the recording medium 110 to perform a division process of the recording file (see step S556 in FIG. 5).

The present disclosure can also be carried out by executing the process described below. That is, software (programs) for implementing the functions of the above-described exemplary embodiments is supplied to a system or device via a network or various storage media, and a computer (or control unit, micro processing unit (MPU), or the like) of the system or device reads and executes the program code. In this case, the programs and the storage media storing the programs constitute the present disclosure.

Although the present disclosure has been described in detail based on the preferred exemplary embodiments, the present disclosure is not limited to these specific exemplary embodiments, and various forms within the scope of the gist of the present disclosure are also included in the present disclosure. Parts of the above-described exemplary embodiments may be combined as appropriate.

Each functional unit in each of the above exemplary embodiments (variations) may or may not be an individual unit of hardware. The functions of two or more functional units may be implemented by a common unit of hardware. Each of a plurality of functions of one functional unit may be implemented by an individual unit of hardware. Two or more functions of one functional unit may be implemented by a common unit of hardware. Each functional unit may or may not be implemented by a hardware unit such as an application specific integrated circuit (ASIC), a field programmable gateway (FPGA), or a digital signal processor (DSP). For example, the apparatus may have a processor and a memory (storage medium) in which control programs are stored. The functions of at least some of the functional units of the apparatus may be implemented by the processor reading and executing the control programs from the memory.

The present disclosure can also be implemented by a process in which programs for implementing one or more functions of the above-described exemplary embodiments are supplied to a system or device via a network or a storage medium, and one or more processors in a computer of the system or device read and execute the programs. The present disclosure can also be implemented by a circuit (for example, ASIC) for implementing one or more functions.

### [Configuration 1]

An information processing apparatus including:
an acquisition unit configured to acquire an imaging start request for requesting start of acquisition of image data or an imaging end request for requesting end of acquisition of the image data from a cooperating apparatus; and
a control unit configured to cause an imaging unit to acquire the image data based on the imaging start request and the imaging end request, and write the image data into a predetermined file in a recording unit,
wherein in a case where the imaging end request acquired by the acquisition unit is not a final imaging end request among imaging end requests corresponding to a plurality of imaging start requests acquired by the acquisition unit, the control unit continues to cause the imaging unit to acquire the image data and changes the file into which the image data is to be written.

### [Configuration 2]

The information processing apparatus according to configuration 1, wherein in a case where the imaging end request acquired by the acquisition unit is the final imaging end request among the imaging end requests corresponding to the plurality of imaging start requests acquired by the acquisition unit, the control unit ends writing of the image data into the file.

### [Configuration 3]

The information processing apparatus according to configuration 2, wherein in a case where the imaging end request acquired by the acquisition unit is the final imaging end request among the imaging end requests corresponding to the plurality of imaging start requests acquired by the acquisition unit, the control unit causes the imaging unit to end acquisition of the image data.

### [Configuration 4]

The information processing apparatus according to any one of configurations 1 to 3, wherein in a case where the acquisition unit acquires the imaging start request when the imaging unit has not acquired the image data, the control unit causes the imaging unit to start acquisition of the image data.

### [Configuration 5]

The information processing apparatus according to configuration 4, wherein in a case where the acquisition unit acquires the imaging start request when the imaging unit has acquired the image data, the control unit continues to cause the imaging unit to acquire the image data and changes the file into which the image data is to be written.

### [Configuration 6]

The information processing apparatus according to any one of configurations 1 to 5, wherein the acquisition unit acquires the plurality of imaging start requests and the imaging end requests from a plurality of cooperating apparatuses.

### [Configuration 7]

The information processing apparatus according to configuration 6, wherein in a case where the acquisition unit acquires the imaging start request, the control unit records in the recording unit, identification information about the cooperating apparatus that has transmitted the imaging start request and an imaging start time at which the imaging start request is acquired, in association with each other.

### [Configuration 8]

The information processing apparatus according to configuration 7, wherein in a case where the acquisition unit acquires the imaging end request, the control unit merges files from the imaging start time associated with the identification information about the cooperating apparatus that has transmitted the imaging end request.

### [Configuration 9]

The information processing apparatus according to any one of configurations 1 to 8, further including the recording unit.

### [Configuration 10]

The information processing apparatus according to any one of configurations 1 to 9, further including the imaging unit.

### [Configuration 11]

A control method for controlling an information processing apparatus, the control method being executed by a computer and including:
acquiring an imaging start request for requesting start of acquisition of image data or an imaging end request for requesting end of acquisition of the image data from a cooperating apparatus; and
causing an imaging unit to acquire the image data based on the imaging start request and the imaging end request, and writing the image data into a predetermined file in a recording unit,
wherein the causing the imaging unit to acquire the image data based on the imaging start request and the imaging end request and writing the image data into the predetermined file in the recording unit includes, in a case where the acquired imaging end request is not a final imaging end request among imaging end requests corresponding to a plurality of imaging start requests acquired by the acquisition unit, continuing to cause the imaging unit to acquire the image data and changing the file into which the image data is to be written.

### [Configuration 12]

A non-transitory computer-readable storage medium which stores a program for causing a computer to execute a control method for controlling an information processing apparatus, the control method comprising:
acquiring an imaging start request for requesting start of acquisition of image data or an imaging end request for requesting end of acquisition of the image data from a cooperating apparatus; and
causing an imaging unit to acquire the image data based on the imaging start request and the imaging end request, and writing the image data into a predetermined file in a recording unit,
wherein the causing the imaging unit to acquire the image data based on the imaging start request and the imaging end request and writing the image data into the predetermined file in the recording unit further includes, in a case where the acquired imaging end request is not a final imaging end request among imaging end requests corresponding to a plurality of acquired imaging start requests, continuing to cause the imaging unit to acquire the image data and changing the file into which the image data is to be written.

According to the present disclosure, it is possible to provide a technology that allows a control apparatus to quickly check imaging results even when a plurality of moving image imaging instructions is transmitted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-055832, filed Mar. 29, 2024, which is hereby incorporated by reference herein in its entirety.

What is claimed is:

1. An information processing apparatus comprising:
one or more memories storing one or more programs; and
one or more processors that, upon execution of the one or more programs, are configured to operate as:
an acquisition unit that acquires an imaging start request for requesting start of acquisition of image data or an imaging end request for requesting end of acquisition of the image data from a cooperating apparatus; and
a control unit configured to cause an imaging unit to acquire the image data based on the imaging start request and the imaging end request, and write the image data into a predetermined file in the one or more memories,
wherein when the acquired imaging end request is not a final imaging end request among a plurality of acquired imaging end requests corresponding to a plurality of acquired imaging start requests, the control unit continues to cause the imaging unit to acquire the image data and changes a file into which the image data is to be written from the predetermined file into a different file.

2. The information processing apparatus according to claim 1, wherein when the acquired imaging end request is the final imaging end request corresponding to the plurality of acquired imaging start requests, the control unit ends writing of the image data into the predetermined file.

3. The information processing apparatus according to claim 2, when the acquired imaging end request is the final imaging end request corresponding to the plurality of acquired imaging start requests, the control unit causes the imaging unit to end acquisition of the image data.

4. The information processing apparatus according to claim 1, when the acquisition unit acquires the imaging start request when the imaging unit has not acquired the image data, the control unit causes the imaging unit to start acquisition of the image data.

5. The information processing apparatus according to claim 4, when the acquisition unit acquires the imaging start request when the imaging unit has acquired the image data, the control unit continues to cause the imaging unit to acquire the image data and changes the predetermined file into which the image data is to be written.

6. The information processing apparatus according to claim 1, wherein the acquisition unit acquires the plurality of imaging start requests and the imaging end requests corresponding to the plurality of imaging start requests from a plurality of cooperating apparatuses.

7. The information processing apparatus according to claim 6, wherein when the acquisition unit acquires the imaging start request, the control unit records, in the one or more memories, identification information about the cooperating apparatus that has transmitted the imaging start request and an imaging start time in association with each other.

8. The information processing apparatus according to claim 7, wherein when the acquisition unit acquires the imaging end request, the control unit merges the predetermined file and any other files from the imaging start time associated with the identification information about the cooperating apparatus that has transmitted the imaging end request.

9. The information processing apparatus according to claim 1, further comprising the imaging unit.

10. A control method for controlling an information processing apparatus, the control method being executed by a computer and comprising:
acquiring an imaging start request for requesting start of acquisition of image data or an imaging end request for requesting end of acquisition of the image data from a cooperating apparatus; and
causing an imaging unit to acquire the image data based on the imaging start request and the imaging end request, and writing the image data into a predetermined file in one or more memories,
wherein the causing the imaging unit to acquire the image data based on the imaging start request and the imaging end request and writing the image data into the predetermined file in the recording unit further includes, when the acquired imaging end request is not a final imaging end request among a plurality of acquired imaging end requests corresponding to a plurality of acquired imaging start requests, continuing to cause the imaging unit to acquire the image data and changing a file into which the image data is to be written from the predetermined file into a different file.

11. A non-transitory computer-readable storage medium which stores a program that, when executed by a computer, causes the computer to execute a control method for controlling an information processing apparatus, the control method comprising:
acquiring an imaging start request for requesting start of acquisition of image data or an imaging end request for requesting end of acquisition of the image data from a cooperating apparatus; and
causing an imaging unit to acquire the image data based on the imaging start request and the imaging end request, and writing the image data into a predetermined file in one or more memories,
wherein the causing the imaging unit to acquire the image data based on the imaging start request and the imaging end request and writing the image data into the predetermined file in the recording unit further includes, when the acquired imaging end request is not a final imaging end request among a plurality of acquired imaging end requests corresponding to a plurality of acquired imaging start requests, continuing to cause the imaging unit to acquire the image data and changing a file into which the image data is to be written from the predetermined file into a different file.
